(19) United States
(12) Patent Application Publication
(10) Pub. No.: US 2013/0128986 A1
(43) Pub. Date: May 23, 2013

(54) Method and Apparatus of Slice Boundary Padding for Loop Filtering

(71) Applicants: Chia-Yang Tsai, New Taipei (TW); Yu-Wen Huang, Taipei (TW); Ching-Yeh Chen, Taipei (TW); Chih-Ming Fu, Hsinchu (TW); Chih-Wei Hsu, Taipei (TW); Shaw-Min Lei, Hsinchu (TW)

(72) Inventors: Chia-Yang Tsai, New Taipei (TW); Yu-Wen Huang, Taipei (TW); Ching-Yeh Chen, Taipei (TW); Chih-Ming Fu, Hsinchu (TW); Chih-Wei Hsu, Taipei (TW); Shaw-Min Lei, Hsinchu (TW)

(73) Assignee: MEDIATEK INC., Hsinchu (TW)

(21) Appl. No.: 13/348,488

(22) Filed: Jan. 11, 2012

Related U.S. Application Data
(60) Provisional application No. 61/563,331, filed on Nov. 23, 2011.

(51) Int. Cl. H04N 7/26

(52) U.S. Cl. 375/240.24; 375/E07.193

(57) ABSTRACT

A method and apparatus for video processing of reconstructed video in a reconstruction loop are disclosed. An embodiment according to the present invention performs padding for the blocks in the slice boundaries according to a processing order. Each of the one or more reconstructed blocks at slice boundaries is padded according to a padding order. In-loop filtering is applied to the reconstructed slice according to the processing order, wherein the reconstructed slice is filtered by referencing the one or more padded blocks. The padding order can be vertical-edge first and then horizontal-edge, or horizontal-edge first and then vertical-edge. Various embodiments are disclosed regarding whether padding for a later padded block in the processing order is skipped or not in the overlapped area. The present invention is also applied to adaptation blocks for block-based in-loop filtering in slice boundaries.

### CROSS REFERENCE TO RELATED APPLICATIONS

The present invention claims priority U.S. Provisional Patent Application, No. 61/563,331, filed Nov. 23, 2011, entitled “Slice Boundary Padding for Adaptive Loop Filter”. The U.S. Provisional Patent Application is hereby incorporated by reference in its entirety.

### FIELD OF THE INVENTION

The present invention relates to video coding. In particular, the present invention relates to coding techniques associated with data padding at slice boundaries for loop filtering.

### BACKGROUND

For digital video compression, intra-prediction and motion compensated inter-frame coding are very effective compression techniques and have been widely adopted in various coding standards, such as MPEG-1/2/4 and H.261/H.263/H.264/AVC. In most coding systems, a macroblock, consisting of 16×16 pixels, is primarily used as a unit for motion estimation and subsequent processing. In the recent development of the next generation standard, named High Efficiency Video Coding (HEVC), a more flexible block structure, termed as coding unit (CU) has been adopted as a unit for processing. During the compression process, various artifacts may be generated. Several in-loop filtering techniques, such as deblocking, adaptive loop filter and adaptive offset, have been used in the reconstruction loop to improve video quality.

In HEVC, a picture may be partitioned into slices and intra-slice coding may be used, where each slice can be processed independently without the need for any data from other slices. When intra-slice processing is used, padding may be required for blocks in the slice boundaries so that the in-loop filtering process will have the needed data to perform the operations without relying on any data outside the current slice. Since the padding process is within the reconstruction loop, the processing order of the blocks and the padding order with respect to the vertical edge and horizontal edge processing has to be determined so that an encoder and a decoder can be configured for correct operation. Furthermore, for corner pixels in the overlapped area at slice boundaries, previous padding results in the processing order may be overwritten by later padding results. In order for the encoder and the decoder to operate properly, the padding process for the overlapped area has to be processed properly.

### BRIEF SUMMARY OF THE INVENTION

A method and apparatus for video processing of reconstructed video in a reconstruction loop are disclosed, wherein each of video pictures is partitioned into slices and each of the slices is partitioned into blocks. In one embodiment according to the present invention, the method for video processing of reconstructed video comprises steps of reconstructing each of the slices to form a reconstructed slice, wherein the reconstructed slice comprises reconstructed blocks; padding one or more reconstructed blocks at slice boundaries according to a processing order to form one or more padded blocks, wherein each of the one or more reconstructed blocks at slice boundaries is padded according to a padding order; and applying in-loop filtering to the reconstructed slice according to the processing order, wherein the reconstructed slice is filtered by referencing the one or more padded blocks. A flag can be used to indicate whether intra-slice processing is enabled or not. The padding order can be vertical-edge first and then horizontal-edge, or horizontal-edge first and then vertical-edge. The padding size can be either fixed or dependent on filter shape associated with the in-loop filtering. One aspect of the present invention addresses whether padding for a later padded block in the processing order is allowed to overwrite padding for a previously processed block in an overlapped area. Another aspect of the present invention addresses derivation of data padding, which includes data repeating, interpolation based on the one or more reconstructed blocks, extrapolation based on the one or more reconstructed blocks, or prediction based on the one or more reconstructed blocks.

A method and apparatus for video processing of reconstructed video in a reconstruction loop are disclosed, wherein each of video pictures is partitioned into slices, and each of the slices comprises adaptation blocks. In one embodiment according to the present invention, the method for video processing of reconstructed video comprises steps of reconstructing each of the slices to form a reconstructed slice, wherein the reconstructed slice comprises reconstructed adaptation blocks; padding one or more reconstructed adaptation blocks at slice boundaries according to a processing order to form one or more padded adaptation windows, wherein each of the one or more reconstructed adaptation blocks at slice boundaries is padded according to a padding order; deriving characteristics based on each of the one or more padded adaptation windows for a corresponding reconstructed adaptation block; and applying in-loop filtering to the corresponding reconstructed adaptation block using a filter selected according to the characteristics. A flag can be used to indicate whether intra-slice processing is enabled or not. The padding order can be vertical-edge first and then horizontal-edge, or horizontal-edge first and then vertical-edge. One aspect of the present invention addresses whether padding for a later processed adaptation block in the processing order is allowed to overwrite padding for a previously processed adaptation block in an overlapped area.

### BRIEF DESCRIPTION OF THE DRAWINGS

FIG. 1A illustrates cross 11×5 filter used for adaptive loop filter (ALF) in HM-4.0.

FIG. 1B illustrates star 5×5 filter used for adaptive loop filter (ALF) in HM-4.0.

FIG. 2 illustrates the 4×4 block and the associated 5×5 window for block-based adaptive loop filter (ALF) used in HM-4.0.

FIGS. 3A-B illustrate an example of padding at slice boundaries with padding overwrite in the overlapped area according to one embodiment of the present intention.

FIGS. 4A-B illustrate another example of padding at slice boundaries with padding overwrite in the overlapped area according to one embodiment of the present intention.

FIGS. 5A-B illustrate an example of padding at slice boundaries with padding overwrite skipped in the overlapped area according to another embodiment of the present intention.

FIGS. 6A-B illustrate another example of padding at slice boundaries with padding overwrite skipped in the overlapped area according to another embodiment of the present intention.

FIGS. 7A-B illustrate an example of padding at slice boundaries with padding overwrite skipped only for the later padding of horizontal edge in the overlapped area according to yet another embodiment of the present intention.

FIGS. 8A-B illustrate another example of padding at slice boundaries with padding overwrite skipped only for the later padding of horizontal edge in the overlapped area according to yet another embodiment of the present intention.

FIGS. 9A-B illustrate an example of padding at slice boundaries with padding overwrite skipped only for the later padding of vertical edge in the overlapped area according to a further embodiment of the present intention.

FIGS. 10A-B illustrate another example of padding at slice boundaries with padding overwrite skipped only for the later padding of vertical edge in the overlapped area according to a further embodiment of the present intention.

### DETAILED DESCRIPTION OF THE INVENTION

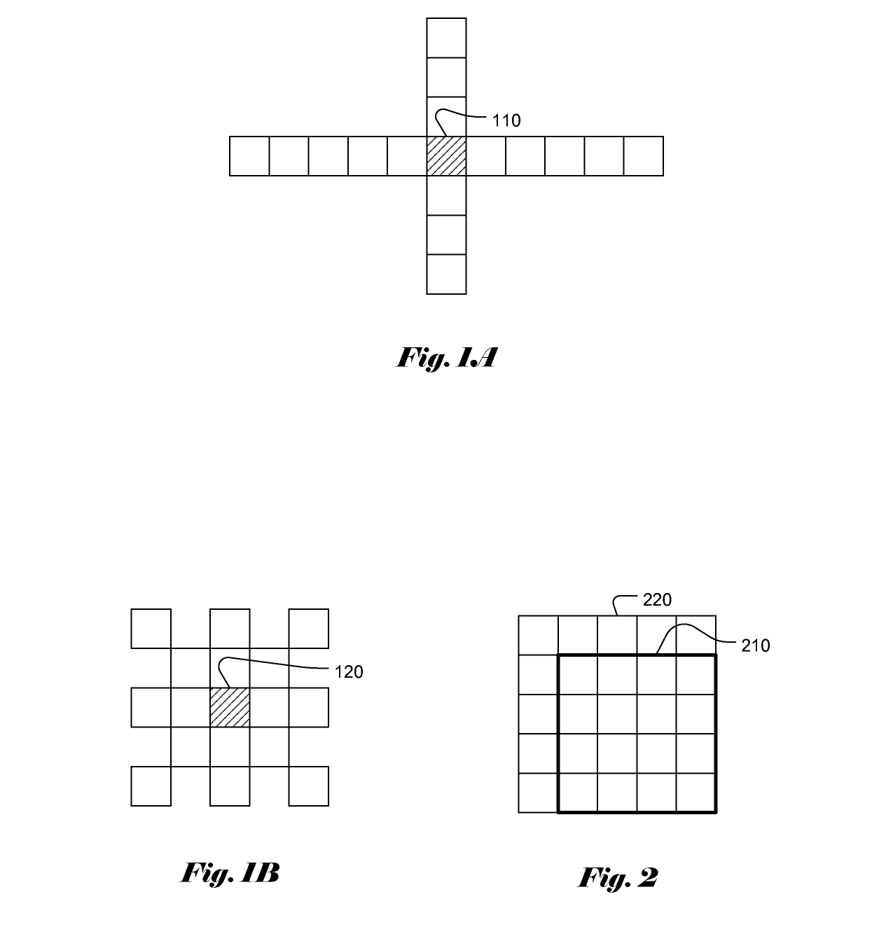

In order to alleviate coding artifacts and improve video quality, filtering, such as deblocking, adaptive offset, and adaptive loop filtering, is often applied to reconstructed video. Furthermore, the filtering usually is configured for in-loop operation so that the filtering process is inside the reconstruction loop. For example, in HEVC Test Model Version 4.0 (HM-4.0), Adaptive Loop Filter (ALF) is applied to the reconstructed and deblocked video data in the reconstruction loop. In HM-4.0, the ALF has two filter shape options: cross 11×5 as shown in FIG. 1A and star 5×5 as shown in FIG. 1B, for luma and chroma. In each picture, the luma component can choose one filter shape and the chroma components can choose one shape of their own. Since the filtering is configured for in-loop operation, a pixel value is updated after the pixel is filtered.

In order to adapt to local characteristic, up to 16 luma filters can be applied to each picture in HM-4.0. In order to allow localization of ALF, there are two modes of determining the characteristic for luma pixels to select filters. One is region-based adaptation (RA), and the other is a block-based adaptation (BA). The RA mode divides one luma picture into 16 regions. Once the picture size is known, the 16 regions are determined and fixed. The regions can be merged, and one filter is used for each region after merging. The BA mode uses edge activity and direction as a property for the block. In order to distinguish the block structure for block-based adaptation from block structure (such as coding unit) for coding or processing, the block for block-based adaptation is termed as adaptation block in this disclosure. The adaptation block used in HM-4.0 consists of 4×4 pixels. The property for each 4×4 block 210, shown as the thick box in FIG. 2, is derived based on a 5×5 window 220, as shown in FIG. 2. The window for adaptation block is termed as adaptation window in this disclosure. After properties of 4×4 blocks are calculated, the blocks are classified into 15 categories. The categories can be merged and one filter is used for each category after merging. As for the chroma components, since they are relatively flat, no local adaptation is used in HM-4.0. The two chroma components of a picture may share one filter to reduce the bit rate associated with the filter.

In U.S. patent application Ser. No. 12/978,490, filed Dec. 24, 2010, an intra-slice processing for in-loop filtering is disclosed, where the in-loop filtering of a slice does not rely on any pixel from other slices. In order to allow intra-slice processing, a pixel outside a currently reconstructed slice is replaced by a pixel in the reconstructed slice. Three boundary padding methods, including horizontal-first, vertical-first, and hamming-distance based padding methods, are disclosed in U.S. patent application Ser. No. 12/978,490.

In an HEVC publication authored by the inventors of this patent application (“Slice Boundary Processing and Picture Layer Raw Byte Sequence Payload”, Joint Collaborative Team on Video Coding (JCT-VC) of ITU-T SG16 WP3 and ISO/IEC JTC1/SC29/WG11, 4th Meeting: Daegu, Korea, 20-28 Jan., 2011, Document No. JCTVC-D128), technique and syntax for slice boundary processing are disclosed. When independent slice processing (i.e., intra-slicing processing) is enabled, the in-loop filtering operation will not be applied cross slice boundaries and padding technique is used to create the needed data corresponding to neighboring slices. The processing order of padding is vertical-edge first and then horizontal-edge. The JCTVC-D128 publication describes one embodiment of the present invention, where padding for blocks at slice boundaries are perform according to the order of vertical-edge first and then horizontal-edge. Furthermore, the padding at slice boundaries is performed only when a flag indicates intra-slice in-loop filtering is enabled. For intra-slice filtering process, there are two kinds of coding schemes: slice-based and CU-based. When slice-based scheme is employed, all CUs in the current slice are padded first, and then filtering is performed for the entire slice. When CU-based scheme is employed, each CU is padded and filtered individually; the filtering process is executed CU by CU. Either slice-based or CU-based coding scheme leads to the same padding results for the entire slice. For the convenience of illustration of the invention, the following descriptions are for slice-based coding scheme. However, if CU-based coding scheme is used, the padding process for CUs will lead to the same results as slice-based scheme.

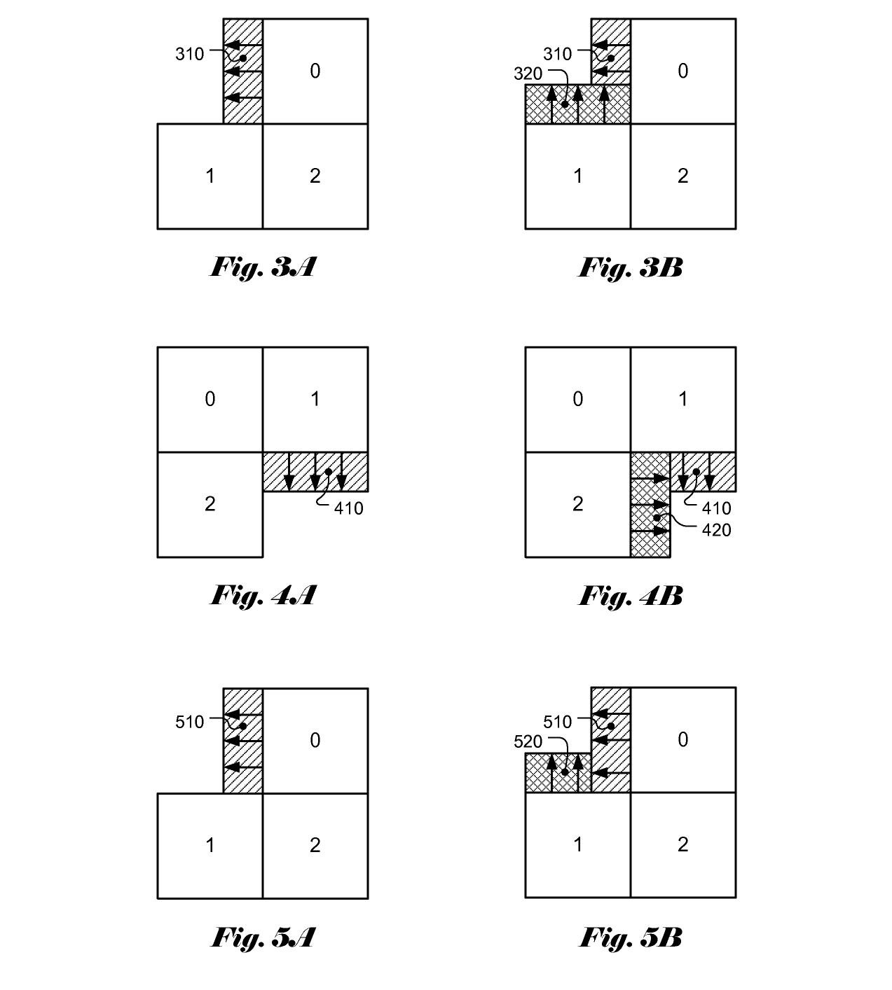

The padding order for blocks at slice boundaries is vertical-edge first and then horizontal-edge, as described in JCTVC-D 128. The padding technique is adopted in HEVC Test Model Version 2.1 (HM-2.1) for ALF. The padding size is fixed in HM-4.0. FIGS. 3A-B and FIGS. 4A-B illustrate one embodiment of slice boundary padding processing of the present invention for two cases of padding respectively. Each block in FIGS. 3A-B and FIGS. 4A-B represents a coding unit (CU). The numbers in FIGS. 3A-B and FIGS. 4A-B indicate the padding order of CUs for in-loop filtering. CU 0 is padded first followed by CU 1 and CU 2. When there are overlapped padded blocks, the padding results of later processed CU in the processing order always overwrite the padding results of a previously processed CU. For the example of FIGS. 3A-B, padded block 310 for CU 0 is formed first. The padded block 320 for the later processed CU 1 overwrites padded block 310 in the overlapped area. For the example of FIGS. 4A-B, padded block 410 for CU 1 is formed first. The padded block 420 for the later processed CU 2 overwrites padded block 410 in the overlapped area. In FIGS. 3A-B and FIGS. 4A-B, only the padded blocks associated with the overlapped area are shown. While the embodiment of the present invention described in HM-4.0 uses the padding order of vertical-edge first and then horizontal-edge, the padding order of horizontal-edge first and then vertical-edge may also be used. The block unit used in the example of FIGS. 3A-B and FIGS. 4A-B is a coding unit (CU). Other block units, such as LCU (largest CU) or a combination of CU and LCU, may also be used to practice the present invention. Slice independent processing allows multiple slices of a picture to be processed concurrently. The slice may be configured to consist of multiple LCUs, multiple CUs, a combination of CUs and LCUs, or other block units to practice the present invention.

The padding size in vertical and horizontal direction can be fixed size or depend on the applied filter shape. For example, in HM-4.0, there are two filter shapes, star5×5 and cross 11×5. If the padding size depends on the filter shape, star5×5 will require 2-pixel padding in vertical and horizontal directions for slice boundaries; cross11×5 will require 2-pixel and 5-pixel padding in vertical and horizontal directions respectively for slice boundaries. If the padding size is a constant, the padding size for horizontal direction can be 5 and for vertical direction can be 2.

In HM-4.0, padding results for a later processed block always overwrites padding results for a previously processed block in the overlapped area. Therefore, pixel data in the overlapped area is generated twice corresponding to padding for two corresponding blocks. Repeated data padding in the overlapped area will increase processing time. However, repeated data padding in the overlapped area may not help to improve picture quality. Therefore, various embodiments according to the present invention skips repeated data padding in the overlapped area in at least one case. For example, in one embodiment, the later padding process will always be skipped in the overlapped area. FIGS. 5A-B and FIGS. 6A-B illustrate examples of padding at slice boundary, where only the padded blocks associated with the overlapped area are shown. The number in each block indicates the padding order for the associated CU. For the corner pixel case associated with FIGS. 5A-B, CU 0 is padded first by forming padded block 510 at vertical edge of CU 0 on the left side as shown in FIG. 5A. CU 1 is padded after CU 0 by forming padded block 520 at horizontal edge on the top side of CU 1 as shown in FIG. 5B. There is an overlapping area between CU 0 padding and CU 1 padding. In this embodiment of the present invention, the padding associated with padding results 520 for CU 1 in the overlapped area will be skipped as shown in FIG. 5B since the padding of the overlapped area has been performed previously during CU 0 padding. In the corner case associated with FIGS. 6A-B, CU 1 is padded by forming padded block 610 at the horizontal edge at bottom of CU 1 as shown in FIG. 6A. CU 2 is then padded by forming padded block 620 at the vertical edge on the right side of CU 2 as shown in FIG. 6B. There is an overlapping area between CU 1 padding and CU 2 padding. In this embodiment of the present invention, the padding associated with padded block 620 for CU 2 in the overlapped area will be skipped as shown in FIG. 6B since the padding of the overlapped area has been performed previously during CU 1 padding. The padding size in vertical and horizontal direction can be fixed size or depend on the applied filter shape.

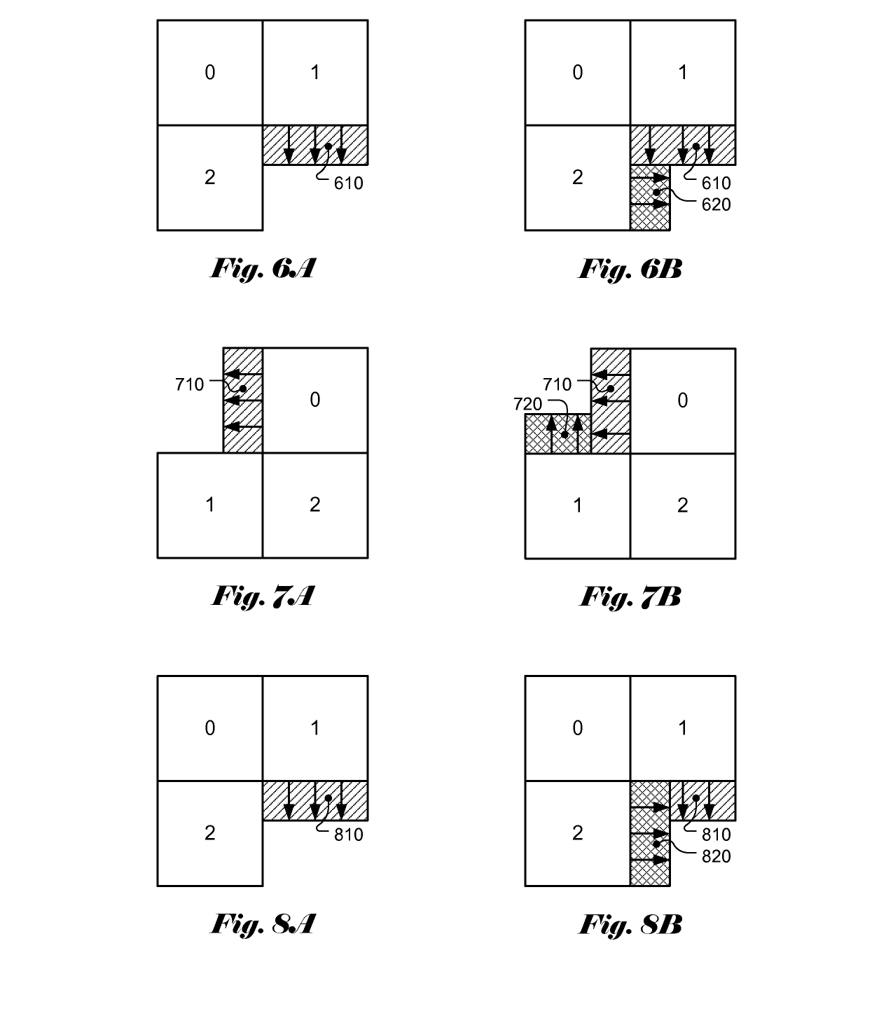

In another embodiment according to the present invention, the later padding process will only be skipped for horizontal edge padding in the overlapped area. In other words, if the later padding process is applied to a vertical edge, the later padding will still overwrite the previous padding in the overlapped area. An example incorporating skipping horizontal edge padding in the overlapped area is shown in FIGS. 7A-B and FIGS. 8A-B for two cases of corner pixels, where only the padded blocks associated with the overlapped area are shown. For the case of corner pixels in FIG. 7A, the padding is performed to the vertical edge on the left side of CU 0 to form padded block 710. After CU 0 padding is done, the padding is performed to the horizontal edge on the top side of CU 1 to form padded block 720. The horizontal edge padding associated with padded block 720 of CU 1 will be skipped in the overlapped area according to the embodiment of the present invention as shown in FIG. 7B. FIGS. 8A-B illustrate the embodiment of the present invention in the other case of corner pixels. Horizontal edge padding is performed on CU 1 to form padded block 810 on the bottom side as shown in FIG. 8A. Vertical edge padding is then performed on CU 2 on the right side to form padded block 820 as shown in FIG. 8B. According to this embodiment of the present invention, the vertical edge padding is still allowed to overwrite the previous padding in the overlapped area as shown in FIG. 8B. The padding size in vertical and horizontal direction can be fixed size or depend on the applied filter shape.

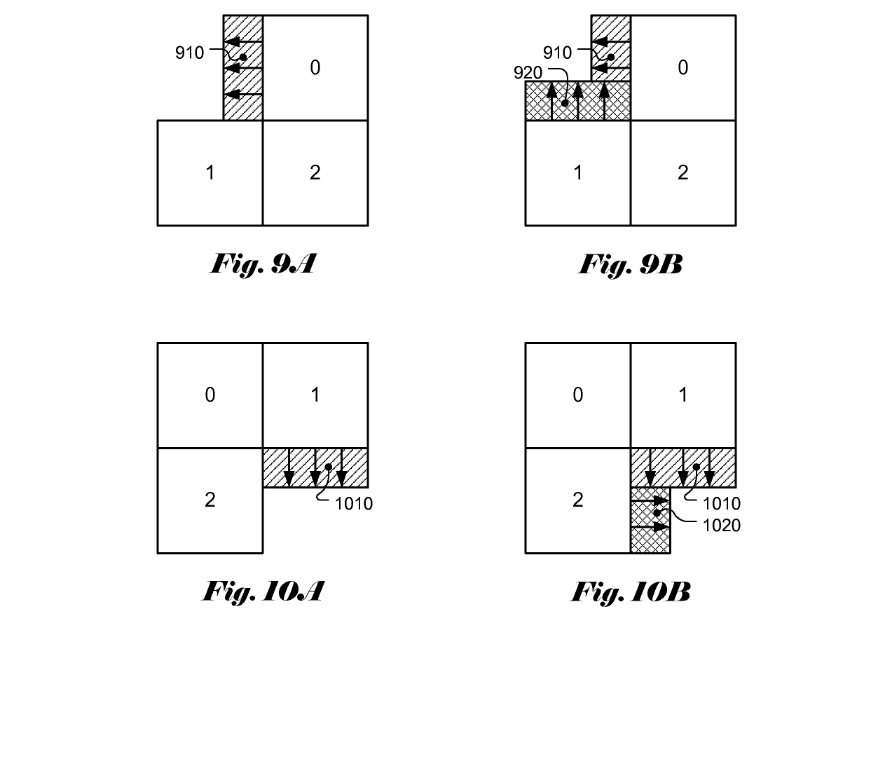

While FIGS. 7A-B and FIGS. 8A-B illustrate an example that the later padding process will only be skipped for horizontal edge padding in the overlapped area, the present invention can also be practiced so that the later padding process will only be skipped for vertical edge padding in the overlapped area. An example incorporating skipping vertical edge padding in the overlapped area is shown in FIGS. 9A-B and FIGS. 10A-B for two cases of corner pixels, where only the padded blocks associated with the overlapped area are shown. For the case of corner pixels in FIG. 9A, the padding is performed to the vertical edge on the left side of CU 0 to form padded block 910. After CU 0 padding is done, the padding is performed to the horizontal edge on the top side of CU 1 to form padded block 920 as shown in FIG. 9B. The horizontal edge padding of CU 1 will overwrite the previous padding in the overlapped area according to the embodiment of the present invention as shown in FIG. 9B. FIGS. 10A-B illustrate the embodiment of the present invention in the other case of corner pixels. Horizontal edge padding is performed on CU 1 on the bottom side to form padded block 1010 as shown in FIG. 10A. Vertical edge padding is then performed on CU 2 on the right side to form padded block 1020. According to the embodiment of the present invention, the vertical edge padding is skipped in the overlapped area as shown in FIG. 10B. The padding size in vertical and horizontal direction can be fixed size or depend on the applied filter shape.

As mentioned earlier, block-based adaptation may be used to allow in-loop filtering with local adaptivity. An example of block-based adaptation is shown in FIG. 2, where the adaptation block 210 consists of 4×4 pixels and the adaptation window 220 consists of 5×5 pixels. Other adaptation block size and adaptation window size may also be used. When an adaptation block coincides with slice boundaries and slice independent in-loop filtering is enabled, padding will also be needed to form the adaptation window required to derive the characteristics for the adaptation block in order to apply adaptivity. For corner pixels in slice boundaries, the situation of padding overwrite will also occur as shown in FIGS. 3A-B and FIGS. 4A-B. Repeated padding in the overlapped area may cause unnecessary operation in the overlapped area. Accordingly, the technique of skipping padding in the overlapped area applied to in-loop filtering may also be applied to the adaptation window generation for deriving characteristics of block-based adaptation. For example, the technique of skipping padding shown in FIGS. 5A-B through FIGS. 10A-B can be applied to generate the pixels in the adaptation window corresponding to pixels outside the current slice. For the exemplary window in FIG. 2, 1-pixel padding in the horizontal and vertical directions is required. The padding can be performed by skipping both vertical and horizontal edges in the overlapped area as shown in FIGS. 5A-B and FIGS. 6A-B. The padding may also be skipped only for the later padding of horizontal edge in the overlapped area as shown in FIGS. 7A-B and FIGS. 8A-B. The padding may also be skipped only for the later padding of vertical edge in the overlapped area as shown in FIGS. 9A-B and FIGS. 10A-B.

In various embodiments of the present invention mentioned above, the padding is performed only when a flag indicates intra-slice enabled. In yet another embodiment of the present invention, intra-slice is always enabled and there is no need for a flag to indicate whether intra-slice is enabled or not.

The padding used in the HM-4.0 simply repeats the pixel at the boundaries horizontally or vertically into the padded block. While data repeating is a simple method of padding, other padding methods may generate better results. There are many other known techniques in the literature for data padding. For example, data extrapolation may be used to generate the padded data. Data extrapolation may be one-dimensional (horizontal or vertical) or two-dimensional. When one-dimensional data extrapolation is used, the pixels in the padded block are derived from other pixels in the same row (horizontal extrapolation) or in the same column (vertical extrapolation). When two-dimensional data extrapolation is used, the pixels in the padded block are derived from pixels in the respective CU. Furthermore, the pixels in the padded block may be derived from pixels in one or more CUs around slice boundaries. For example, the padded pixels for the vertical edge of CU 0 in FIG. 3A may be derived from pixels in CU 0, CU 0 and CU 1, CU 0 and CU 2, or all three CUs (CU 0, CU 1 and CU 2). The derivation of padded pixels from one or more CUs can be based on any mathematic method such as interpolation, extrapolation, prediction, and curve fitting.

Besides the one-dimensional and two-dimensional extrapolation, the padded area can also be derived by the to-be-filtered pixel itself during the filtering process. This kind of padding technique can be regarded as a simplified data extrapolation method. For example, if a to-be-filtered pixel requires referencing a neighboring pixel from any of other slices when intra-slice processing is enabled, the neighboring pixel outside the current slice boundary is replaced by the to-be-filtered pixel itself. In this case, the padding technique derives the padded pixels using the to-be-filtered pixels instead of the boundary pixels within the slice boundary.

The invention may be embodied in other specific forms without departing from its spirit or essential characteristics. Embodiments of block padding at slice boundaries according to the present invention as described above may be implemented in various hardware, software codes, or a combination of both. For example, an embodiment of the present invention can be a circuit integrated into a video compression chip or program codes integrated into video compression software to perform the processing described herein. An embodiment of the present invention may also be program codes to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware codes may be developed in different programming languages and different format or style. The software code may also be compiled for different target platform. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method for video processing of reconstructed video in a reconstruction loop, wherein each of video pictures is partitioned into slices and each of the slices is partitioned into blocks, the method comprising:
reconstructing each of the slices to form a reconstructed slice, wherein the reconstructed slice comprises reconstructed blocks;
padding one or more reconstructed blocks at slice boundaries according to a processing order to form one or more padded blocks, wherein each of the one or more reconstructed blocks at slice boundaries is padded according to a padding order; and
applying in-loop filtering to the reconstructed slice according to the processing order, wherein the reconstructed slice is filtered by referencing the one or more padded blocks.

2. The method of claim 1, wherein said padding the one or more reconstructed blocks at the slice boundaries is performed when a flag indicates that intra-slice processing is enabled.

3. The method of claim 1, wherein the padding order is vertical-edge first and then horizontal-edge.

4. The method of claim 1, wherein the padding order is horizontal-edge first and then vertical-edge.

5. The method of claim 1, wherein padding size for said padding the one or more reconstructed block at the slice boundaries is fixed or dependent on a filter shape associated with the in-loop filtering.

6. The method of claim 1, wherein padding results of said padding the one or more reconstructed blocks at the slice boundaries for a later padded block in the processing order overwrites the padding results for a previously padded block in an overlapped area.

7. The method of claim 1, wherein said padding the one or more reconstructed blocks at the slice boundaries for a later padded block in the processing order is skipped in an overlapped area.

8. The method of claim 1, wherein said padding the one or more reconstructed blocks at the slice boundaries associated with horizontal edge padding of a later padded block in the processing order is skipped in an overlapped area.

9. The method of claim 1, wherein said padding the one or more reconstructed blocks at the slice boundaries associated with vertical edge padding of a later padded block in the processing order is skipped in an overlapped area.

10. The method of claim 1, wherein said padding the one or more reconstructed blocks at the slice boundaries derives padded pixels according to data repeating, interpolation based on the one or more reconstructed blocks, extrapolation based on the one or more reconstructed blocks, or prediction based on the one or more reconstructed blocks.

11. The method of claim 1, wherein said padding the one or more reconstructed blocks at the slice boundaries derives a padded pixel associated with a current processing to-be-filtered pixel by replacing pixels outside the slice boundaries with the current to-be-filtered pixel.

12. A method for video processing of reconstructed video in a reconstruction loop, wherein each of video pictures is partitioned into slices, and each of the slices comprises adaptation blocks, the method comprising:
reconstructing each of the slices to form a reconstructed slice, wherein the reconstructed slice comprises reconstructed adaptation blocks;
padding one or more reconstructed adaptation blocks at slice boundaries according to a processing order to form one or more padded adaptation windows, wherein each of the one or more reconstructed adaptation blocks at slice boundaries is padded according to a padding order;
deriving characteristics based on each of the one or more padded adaptation windows for a corresponding reconstructed adaptation block; and
applying in-loop filtering to the corresponding reconstructed adaptation block using a filter selected according to the characteristics.

13. The method of claim 12, wherein said padding the one or more reconstructed adaptation blocks at the slice boundaries is performed when a flag indicates that intra-slice processing is enabled.

14. The method of claim 12, wherein the padding order is vertical-edge first and then horizontal-edge.

15. The method of claim 12, wherein the padding order is horizontal-edge first and then vertical-edge.

16. The method of claim 12, wherein padding results of said padding the one or more reconstructed adaptation blocks at the slice boundaries for a later padded adaptation block in the processing order overwrites the padding results for a previously padded adaptation block in an overlapped area.

17. The method of claim 12, wherein said padding the one or more reconstructed adaptation blocks at the slice boundaries for a later padded adaptation block in the processing order is skipped in an overlapped area.

18. The method of claim 12, wherein said padding the one or more reconstructed adaptation blocks at the slice boundaries associated with horizontal edge padding of a later padded adaptation block in the processing order is skipped in an overlapped area.

19. The method of claim 12, wherein said padding the one or more reconstructed adaptation blocks at the slice boundaries associated with vertical edge padding of a later padded adaptation block in the processing order is skipped in an overlapped area.

20. An apparatus for video processing of reconstructed video in a reconstruction loop, wherein each of video pictures is partitioned into slices and each of the slices is partitioned into blocks, the apparatus comprising:
means for reconstructing each of the slices to form a reconstructed slice, wherein the reconstructed slice comprises reconstructed blocks;
means for padding one or more reconstructed blocks at slice boundaries according to a processing order to form one or more padded blocks, wherein each of the one or more reconstructed blocks at slice boundaries is padded according to a padding order; and
means for applying in-loop filtering to the reconstructed slice according to the processing order, wherein the reconstructed slice is filtered by referencing the one or more padded blocks.

21. An apparatus for video processing of reconstructed video in a reconstruction loop, wherein each of video pictures is partitioned into slices, and each of the slices comprises adaptation blocks, the apparatus comprising:
means for reconstructing each of the slices to form a reconstructed slice, wherein the reconstructed slice comprises reconstructed adaptation blocks;
means for padding one or more reconstructed adaptation blocks at slice boundaries according to a processing order to form one or more padded adaptation windows, wherein each of the one or more reconstructed adaptation blocks at slice boundaries is padded according to a padding order;
means for deriving characteristics based on each of the one or more padded adaptation windows for a corresponding reconstructed adaptation block; and
means for applying in-loop filtering to the corresponding reconstructed adaptation block using a filter selected according to the characteristics.
